(19) United States
(12) Patent Application Publication
(10) Pub. No.: US 2004/0249707 A1
(43) Pub. Date: Dec. 9, 2004

(54) Principal guaranteeing game system, gaming method using the same on internet and storage media for the same

(76) Inventor: Seo-Kyu Park, Seoul (KR)

Correspondence Address: DEMONT & BREYER, LLC, SUITE 250, 100 COMMONS WAY, HOLMDEL, NJ, 07733, US

(21) Appl. No.: 10/490,816

(22) PCT Filed: Sep. 24, 2002
(86) PCT No.: PCT/KR02/01802

(30) Foreign Application Priority Data
Sep. 26, 2001 (KR) 0159783
Sep. 23, 2002 (KR) 0257584

(51) Int. Cl. G06F 17/60; A63F 9/24; A63F 13/00; G06F 17/00; G06F 19/00

(52) U.S. Cl. 705/14; 705/26; 463/1

(57) ABSTRACT

A principal guaranteeing game system, gaming method using the same on the internet and a storage media. The principal guaranteeing system on the internet and a recording medium of the same make a user play a game during a period determined according to a purchase amount by giving a game point as much as the purchase amount of an item and award a certain amount of property based on a game point obtained in the game. In order to achieve the above objects, there are provided an operator server 12 which guides and purchase an item, a game server 14 for executing and processing a game, and a terminal 16 of each member.

### TECHNICAL FIELD

The present invention relates to an item purchase and game system on the internet, and in particular to a principal guaranteeing game system, gaming method using the same on the internet and a storage media for the same which are capable of providing a game point corresponding to a purchase principal of an item to a purchaser who purchases an item on the internet and allowing a purchaser to play a game during a certain period determined according to the purchase principal of the item and awarding a certain amount of money corresponding to a game point obtained during the game.

### BACKGROUND ART

As the technology of an internet is advanced, the number of people who plays a game in real time on the internet and want to purchase a certain item through an electronic commerce transaction is gradually increased. For example, the games serviced through the internet are an electronic game such as a slot machine, video game, kino, etc, and a card game such as a poker, go-stop, etc.,and a traditional game such as a yut game, Korean chess, a game of baduk, or go, etc., and a puzzle game in which wrong-arranged pictures are corrected, and a shooting game such as a fortress, etc. The above games may be charged or provided for free.

Among the above games, the charged games are designed in such a manner that only if a user pays a certain amount of money, a certain electronic point, a mileage point or a certain item, he/she can participate in the game. The above charged games make, the use increase or decrease his/her money, scores, mileage points or the items such as a certain weapon used in the game according to a result of the game. Since the money, score, mileage point or items are managed by each user, if the user repeatedly loses the game, the user may lose his/her money, score, mileage point or items, thereby the user may not participate in the game and may have an economical loss. Namely, the user may lose all his/her principal to pay for the game at the beginning time.

In the meantime, the electronic commercial transaction through the internet is performed between a seller and a buyer as the seller provides the item on an internet shopping mall, and the buyer selects one of the items and pays money corresponding to the selected item. Here, the buyer can pay the money corresponding to the selected item to the seller by remitting money or settling with a credit card. Therefore, since the electronic commercial transaction does not requires, a place for displaying and selling items to the seller and a visitation of a place displaying items to the buyer, the cost of the items can be reduced, thereby the buyer is capable of buying the items at a relatively lower price. However, in the electronic transaction, the items of lower prices (for example, less than 1,000,000 won) are generally transacted. Namely, particular items (for example, various bonds, real estates, gold membership card, etc.) are not transacted.

Therefore, in the prior art electronic commercial transaction and internet game using an internet technology, the users must use them separately, and in the case of a charged internet game, if a player of the charged internet game loses a principal, the player cannot receive any compensation with respect to the lost principal therefrom.

### DETAILED DESCRIPTION OF THE PRESENT INVENTION

Accordingly, it is a primary object of the present invention to provide a principal guaranteeing game system, a gaming method using the same on the internet and a storage media for the same which are capable of providing a buyer who buys an item through a wire or wireless internet with a game point corresponding to a purchase principal of an item, allowing the buyer to play a game during a certain period determined according to the purchase principal, and guaranteeing the item corresponding to the principal, to the buyer, irrespective of a game point.

It is another object of the present invention to provide a principal guaranteeing game system, a gaming method using the same on the internet and a storage media for the same which are capable of providing a buyer who buys an item through a wire or wireless internet with a game point corresponding to a purchase principal of the item, allowing the buyer to play a game during a certain period determined according to the purchase principal, and returning a certain amount of money corresponding to a game point obtained during the game.

In order to achieve the above objects, there is provided a principal guaranteeing game system on an internet, comprising: (1) servers 12 and 14 including: (1-i) a means for transferring an item data including an item name, item price, and a period determined according to the item purchase principal to an internet 10; (1-ii) a judging means for receiving a purchase data of the item from a member and judging whether a purchase condition is satisfied; (1-iii) a giving means for outputting a delivery instruction of the item based on the purchase data and giving a game point corresponding to the item price to the member; (1-iv) a game means for proceeding a game on the internet using the game point and for increasing or decreasing the game point according to a result of the game; (1-v) a period expiration judging means for judging whether or not the period determined according the item purchase principal is expired; (1-vi) a game point judging means for judging whether there is a game point obtained in the game with respect to a game point increased or decreased by the game means; and (1-vii) a remitting means for remitting a property corresponding to the game point obtained in the game to an account of a corresponding member in the case that the period determined according to the item purchase principal is judged to be expired by the period expiration judging means, and the game point obtained in the game is judged to be remained by the game point judging means; and (2) a terminal 16 including: (2-i) a receiving means for receiving the item data through the internet 10; (2-ii) a purchase data transferring means for receiving the purchase data and transferring to the server 12 and receiving the game point; and (2-iii) a betting means for being cooperated with the game means and betting the game by increasing or decreasing the game point.

The game means includes an electronic game such as a card game or slot machine, video game, and kino, and a card game such as a porker game, go-stop game.

The purchase data is a bank name, account number, password, amount, purchaser's name data, and security password, etc.

The purchase condition further includes the kinds of a payment means and a determination whether a payment of the item is paid.

The payment means is a non-bankbook input, credit card, cash card, money stored card, cellular phone payment, and PDA means.

The server is connected with a wire or wireless internet using a personal computer, PDA and a cellular phone.

The items are sold in a shopping mall of other internet company cooperated with the game site managed by that of other internet company.

The game point allocated to the item sold in the shopping mall managed by another internet company is relatively smaller than a game point allocated to the same item sold in a shopping mall managed by an internet company together with the game site.

In order to achieve the above object, there is provided a principal guaranteeing game method on the internet, comprising the steps of: preparing step, including: connecting through the internet; and registering a member or logging in; purchasing an item; transferring an item data including a name of the purchased item, price of the purchased item, a period determined according to a purchase principal of the purchased item to a terminal (16) through the internet (10) and displaying the same on the terminal; transferring a purchase data of the item inputted from the member computer (16) to the server (12) and judging whether the purchase date is satisfied with a purchase condition; outputting an item delivery instruction based on the purchase data in the case that the purchase date is satisfied with the purchase condition, and giving a game point corresponding to the price of the item to the member; betting the game using a game point and participating the game on the internet (10) and increasing or decreasing the game point based on a result of the game; judging whether the period determined according to the purchase principal of the item data is expired; judging whether there is a game point obtained in the game when the period determined according to the purchase principal of the item is expired; providing property corresponding to the game point obtained in the game when the period determined according to the purchase principal of the item data is expired and there is a game point obtained in the game; and preventing the user from participating the game when there is not a game point obtained in the game.

In addition, if the period determined according to the purchase principal of the item is not expired, and there is a game point obtained in the game, the user continuously participates the game.

The step for providing a property further includes a step for re-purchasing an item in a shopping mall in which it is possible to purchase the items.

The above property includes an electronic money and cash, etc.

In order to achieve the above objects, there is provided a recording medium capable of being executed in a computer, comprising: a program code in which a user connected through a wired or wireless internet registers as a member or a previously registered member logs in; a program code in which an item data including a name of a purchased item (S10), a price of the purchased item, and a period determined according to a purchase principal of the purchased item to a terminal (16) through the internet; a program code in which the purchased data of the item inputted from the member computer (16) is transferred to the server (12) and the purchased data is judged to be satisfied with the purchase condition; a program code in which a delivery instruction of the item is outputted based on the purchase data when the purchase condition is satisfied, and the game point corresponding to the price of the item is given to the member; a program code in which the game is proceeded on the internet (10) based on the betted game point and the game point is increased or decreased based on a result of the game; a program code in which it is judged whether the period determined according to the purchase principal of the item data is expired; a program code in which it is judged whether there is a game point obtained in the game when the period determined according to the purchase principal of the item is expired; a program code in which an instruction for outputting a property corresponding to the game point obtained in the game is outputted, in the case that the period determined according to the purchase principal of the item data is expired and there is a game point obtained in the game; and a program code in which the user is prohibited to participate the game, if there is not a game point obtained in the game.

The present invention will become better understood with reference to the accompanying drawings which are given only by way of illustration and thus are not limitative of the present invention.

### BRIEF DESCRIPTION OF THE DRAWINGS

FIG. 1 is a view illustrating a schematic construction of a game system capable of guaranteeing a principal on the internet according to the present invention;

FIG. 2 is a view illustrating a database server included in an operator server 12 of FIG. 1;

FIG. 3 is a view illustrating a schematic construction of a window displaying an item purchase information on a monitor according to the present invention;

FIG. 4 is a view illustrating a window noting an item sold to a user and a game point provided to the user on the monitor, when the purchase determination of the item displayed on the window of FIG. 3 is transferred according to the present invention;

FIG. 5 is a view illustrating a schematic construction of user interface window in a game executed by the principal guaranteeing game system on the internet according to the present invention; and

FIG. 6 is a flow chart illustrating an operation method of a principal guaranteeing game system on the internet according to the present invention.

### PREFERRED EMBODIMENTS OF THE PRESENT INVENTION

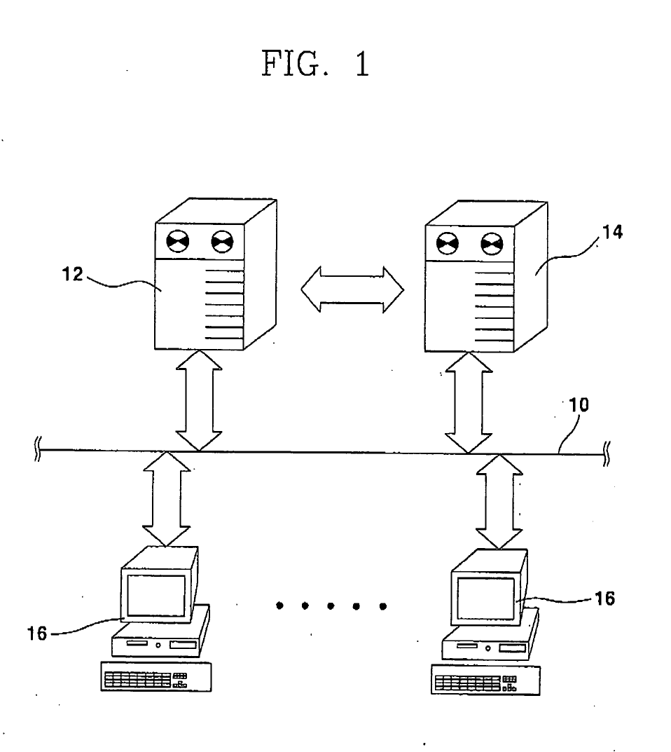

FIG. 1 is a view illustrating a schematic construction of a game system capable of guaranteeing a principal on the internet according to the present invention. As shown therein, the principal guaranteeing game system includes an operator server 12, a game server 14 which operates and manages a game, and a terminal 16 connected with the operator server 12 and the game server 14 through the internet 10.

The operator server 12 is adapted to control, operate and manage the system, and includes a database server for storing information of members for managing the members, an e-mail server, a SQL server and a FTP server.

The terminal 16 includes a computer receiving a content or service from the operator server 12 and the game server 16, and a plurality of computers connected to a LAN. Here, the terminal 16 and the servers 12 and 14 communicate each other based on a TCP/IP or PPP method. The game server 14 executes a game program exclusively operated therein, stores data such as member information, game score, game difficulty and information of a game previously executed and executes the game program again. In addition, the game server 14 is capable of receiving a game point for the game from the operator server 12 and transmits the game point obtained from a result of the game to the operator server 12. Here, the game server 14 executes an electronic game such as a slot machine, video game, kino, etc., a card game such as a poker, a go-stop game, etc., a traditional game such as a yut game, Korean chess, a game of baduk, or go, chess etc., a shooting game such as a fortress, etc., a strategy simulation game, an arcade game, and a puzzle game, etc.

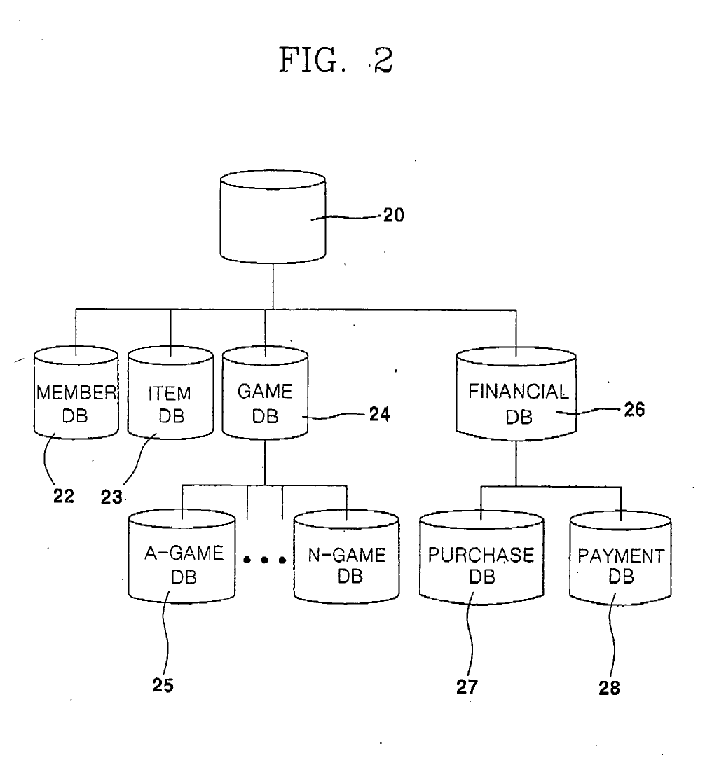

FIG. 2 is a view illustrating a structure of a database server included in an operator server of FIG. 1. The database server includes main database (main DB) 20, a member DB 22 which is connected with the main DB and stores member information, an item DB 23 which is connected with the main DB and stores item information, a game DB 24 which is connected with the main DB and stores game information, a financial DB 26 which is connected with the main DB and stores financial organ information, a purchase DB 27 which operates in connection with the financial DB 26 and stores purchase information, and a payment DB 28 which operates in connection with financial DB 26 and stores property information which is paid to the members. In addition, the game DB 24 further includes a plurality of game sub-DBs 25.

Here, the main DB includes a table concerning a plurality of sub-DBs defined in its substructure. The main DB and the plurality of sub-DBs operate each other in a master-slave or primary-secondary relationship.

The member DB 22 includes fields in which member ID, password, name, sex, resident registration number, address, contact information, e-mail address, name of bank, account number, and name of owner of bankbook, etc. are defined.

The item DB 23 includes fields in which the number of sale events, item name, price, period or game participation period determined according to a principal of the purchase, quantity, amount of sale, stock, model name, and period, etc. are defined.

The game DB 24 further includes a game sub-DB formed based on the kinds of games. The game sub-DB includes games A, B, . . . , N game DBs. For example, the A game sub DB stores information concerning the go-stop game, and the B game sub DB stores information concerning the porker game, and the N game sub-DB stores information concerning the Korean chess.

The financial DB 26 stores and manages information concerning a purchase and delivery of an item and an award of the game point obtained in the game. The financial DB 26 further includes a sub-DB such as a purchase DB 27 and a payment DB 28.

The purchase DB 27 stores and manages a purchase information that each member inputs and transfers. The purchase DB 27 includes fields in which a name of bank, account, password, money, a name of purchaser, an address of item delivery, delivery date, etc. are defined.

In the case that a game point obtained in the game is awarded in cash or electronic money the payment DB 28 stores and manages an information related to the awarding method. The payment DB includes files, for example, in which a point obtained in the game, game period, game validation period, name of member, name of bank, account, kinds of award (for example, cash, electronic money, game point obtained in the game, and other items) are defined.

The operation of the principal guaranteeing system on the internet according to the present invention will be described together with a graphic user's interface displayed on the monitor of the terminal.

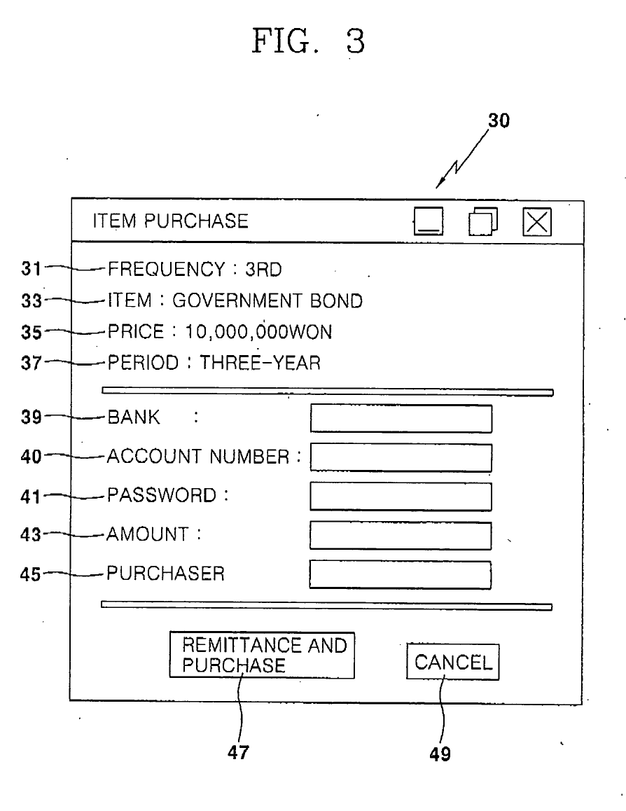

FIG. 3 is a view illustrating a schematic construction of a window in which an item purchase information is displayed on a screen of a monitor. The window 30 includes an item information display portion in which an item information transferred from the operator server 12 to a member terminal 16 is displayed on the monitor of the member terminal 16, a member purchase information input portion in which a purchase information of a member is inputted for purchasing an item displayed on the item information display portion, and a purchase determination input portion for purchasing an item displayed and inputting a cancellation of the purchase.

The item information display portion includes a display portion in which a frequency of purchase events 31, a name of item 33, a price of item 35 and a period for playing the game determined based on a purchase principal of the item are displayed. The above construction will be described in detail.

The price 35 represents a price of items provided in the shopping mall of a site operator after the site operator buys the items. For example, if the site operator buys a three-year government bond for 8,500,000won and sells to each member for 10,000,000won, the game point of 10,000,000won is given to a coupon of the government bond.

The period 37 determined according to the purchase principal is determined based on the kinds of item or characteristic, and represents a limited time for playing the game. For example, the period 37 may be set in a range from one month to five years by the unit of one month or one week. In addition, the period 37 may be a period that the property corresponding to the game point obtained in the game is returned to the user after the user plays the game.

For example, in the case that the item information display portion displays that the frequency is 1, the item is an apartment, the price is 100,000,000won, and the period is 3, it means that the game period is 3 years with respect to the item of apartment of 100,000,000won which is provided in the first event. Similarly, and if the item information display portion shows that the frequency is 2, the item is a golf membership card, the price is 50,000,000won, and the period is 2, it means that the game playing period is 2 years with respect to the golf membership card of 50,000,000won in the second event. In addition, if the item information display portion indicates that the frequency is 3, the item is a government bond, the price is 10,000,000won and the period is 1, it means that the game playing period is 1 year with respect to the government bond of 10,000,000won in the third event.

When purchasing the item displayed on the item information display portion, the purchase information input portion filled out by a user includes the member input portion includes an input portion formed of a name of bank 39, account number 40, password 41, amount 43, and name of a purchaser 45.

The name of bank 39 represents an input portion inputting a name of bank in which a member's money is deposited, and the account number 40 represents an input portion in which an inherent number of the member's bankbook is inputted, and the password 41 represents an inherent number determined by the member for depositing and withdrawing money through the banknote, and the amount 43 represents an input portion in which the price 3of the item is inputted. The purchaser 4is an specifically prepared input portion for considering a case that the member's name and the remitter may be different each other for the item. In addition, the item information display portion may further include a password for security, which is not shown in the drawings.

The purchase determination input portion includes a remittance and purchase button 47, and a cancellation button 49.

When the remittance and purchase button 47 is performed, the above information is transferred to the operator server 12, thereby a corresponding money 43 is inputted into the bankbook of the account number of the operator's bank previously set in the operator server 43. Here, the paying method including the method for transferring money from the account number of the user's bank to the operator's account may further includes a method such as a credit card, cellular phone payment, and electronic money, etc.

When the cancellation button 49 is performed, all information inputted are cancelled, and the window disappears from the monitor.

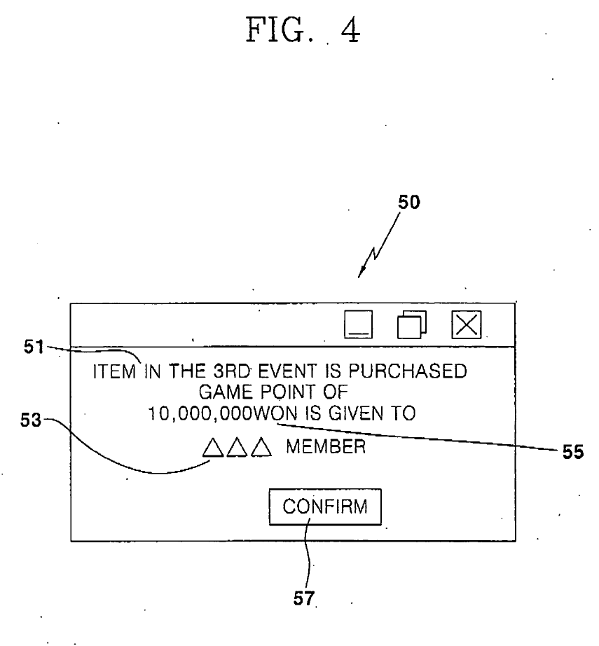

FIG. 4 is a view illustrating a window an item sold to a user and a game point provided to the user on the monitor, when the purchase determination of the item displayed on the window of FIG. 3 is transferred according to the present invention. When the item purchase information that the item purchaser inputted is transferred to the operator server 12 and is verified, the operator server 12 prints a delivery instruction for instructing a delivery of a corresponding item and sent it to a transfer service company.

As shown in FIG. 4, the operator server 12 noting a guide information to a member(53 of FIG. 4) in which the purchase is completed and a game point (55 of FIG. 4) corresponding to the purchased item is given. Then, the member checks the contents in the information guide displayed on the window of FIG. 4 and performs the confirmation button 57, ‘CONFIRM’ and deletes the window 50.

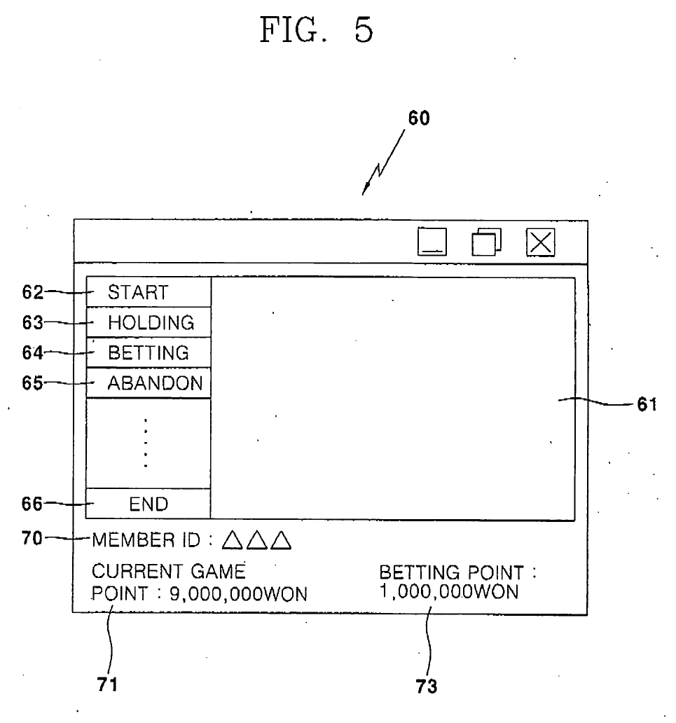

FIG. 5 is a view illustrating a schematic construction of user interface window in the game executed by the principal guaranteeing game system on the internet according to the present invention.

As shown therein, the window 60 includes a game display portion 61 for displaying proceeding state of a game in graphic, various button portions formed near one side of the game display portion 61 for selecting a state needed for the procedure of the game, and a game state display portion for displaying a member information and a game state in a lower portion of the game window 61. Here, the procedure button portion 61 includes a start button 62, a holding button 63, a betting button 64, an abandonment button 65, and an end button 66. The game state display portion includes a member's ID 70 logged in the current game, a game point 71 currently remains and a betting point 73 for a game when a user participates the game displayed on the game display portion 61.

Meanwhile, the window 60 may further include a chatting window for chatting with a certain opponent, a time lapse data, a preference, and a period to participating in a game in the future, which is a difference from a period 37 capable of participating the game to a period participated in the game in the past of the period 37.

The operation of the principal guaranteeing game system on the internet according to the present invention will be described with reference to the accompanying drawings.

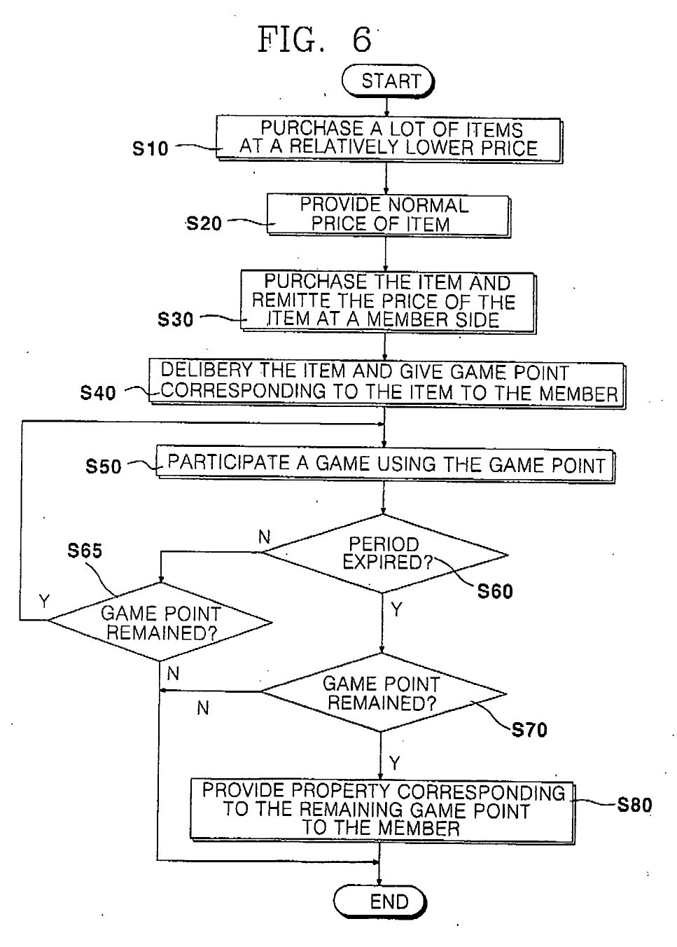

FIG. 6 is a flow chart illustrating an operation method of a principal guaranteeing game system on the internet according to the present invention.

First, the user must register for using the principal guaranteeing game system on the internet according to the present invention. The registering is performed based on a well-known registering method, thereby the registered member has a member ID and a password. Therefore, if the registered member inputs his/her member ID and password, he/she can log in into the internet site provided by the principal guaranteeing game system.

The operator of the principal guaranteeing game system on the internet according to the present invention purchases items from the items manufacturer in order to sell the items on the operator's site (i.e., his/her shopping mall) (S10). Here, since the operator buys a lot of the items, the operator can purchase the items at a relatively lower price compared to the price when a small amount of item is purchased and can obtain a profit with respect to the items when the items are sold in the shopping mall. For example, in the case that the 3-year government bond of 10,000,000won is currently 8,500,000won, the operator may have a profit of about 1,500,000won by buying a large amount of the government bond of 8,500,000won.

Next, as shown in the window of FIG. 3, the name of item, price of the same, and an item data concerning the period are provided to the terminal 16 of each member through the internet in order for the member to determine the purchase of the items. At this time, the price of the item is not the amount that the operator purchased the item(for example, 8,500,000won), but the indicated price of the item(for example, 10,000,000won)(S20).

In the case that a certain member has an intention to purchase the item, as shown in FIG. 3, the member inputs a purchase information in the blanks and transfers the information to the operator server 12 through the internet 10. The operator server 12 checks a purchase condition that whether there is a non-inputted information or property is lack or an information concerning the bank is correct(S30).

If the purchase condition is satisfied, the operator server 12 further judges whether money corresponding to the price of the item is paid. As a result of the judgment, if the corresponding money is paid, an item delivery instruction is outputted based on the purchase data, and a game point corresponding to the price of the item(if the price of the item is 10,000,000won, the game point is 10,000,000won) is given to the member(S40). Next, a guide information, as shown in FIG. 4, is outputted to the member, so that the result of the transaction is checked by the member.

Here, a method of the payment, a credit card, non-bankbook deposit, cellular phone, PDA or electronic money may be used.

When the game point is received, a corresponding member selects a game among a plurality of games and determines the betting amount (or point) for thereby starting the game. As the user repeatedly plays the game, his/her game point is increased or decreased according to a result of the game(S50). For example, when a user plays a game with 10,000,000won, in which the user can obtain or lose money doubly with respect to his/her betting money whether wining or losing the game, if the user bets 100,000won and wins the game his/her money is increased to 10,200,000won, and If the user loses the game, his/her money is decreased to 9,600,000won.

While the game is repeatedly performed in the above manner, the operator server 12 judges whether the period 37 determined according to the purchase principal is expired (S60). For example, the period 37 determined according to the purchase principal may be judged whether it is expired or not by checking whether today is in the period 37 (for example, three years).

If the period 37 determined according to the purchase principal is expired, the operator server 12 judges whether there is a game point obtained in the game(S70).

If the period 37 determined according to the purchase principal of the item data is expired and there is a game point obtained in the game, the property (for example, if the point obtained in the game is 200,000won, 200,000won is given in cash or electronic money) corresponding to the game point obtained in the game is given (S80). Here, the user may purchase a certain item in the internet shopping mall using the game point obtained in the game, again, thereby receiving a coupon (with the game point) of the purchased item, again.

If there is not a game point obtained in the game or the user does not have a game point, the user can not participate the game (S65).

Therefore, in order to re-obtain the game point for participating the game, the user must purchase a new item in the shopping mall, thereby obtaining a game point corresponding to the purchased item.

Now, the recording medium for storing a program which operates the principal guaranteeing game system on the internet and reading a stored data in the computer will be described.

The system according to the present invention is executed based on a recording medium storing program codes, which is executed based on a computer or a mobile communication system such as a cellular phone, PDA. Here, the recording medium stores that a program code for registering a user connected through the internet thereto as a member and making the member log in, a program code in which a certain item is purchased (S10), and an item data including a name of item, price of item and period is transferred to the terminal 16 through the internet 10, a program code transferring the purchase data of the item inputted through the member's computer to the operator server 12 and determining whether the purchase data is satisfied with the purchase condition, a program code in which a delivery instruction of the item is outputted based on the purchase data if it is satisfied with the purchase condition, and the game point corresponding to the purchase data of the item is given to the user, a program code in which the game is proceeded on the internet 10 based on the betted game point and the game point is increased or decreased based on a result of the game, a program code determining whether or not the period determined according to the purchase principal of the item data is expired, a program code determining whether or not there is a game point obtained in the game if the period determined according to the purchase principal is expired, a program code in which if the period determined according to the purchase principal of the item data is expired and there is a game point obtained in the game, an instruction for providing the property corresponding to the game point obtained in the game to the user is outputted, and a program code in which if there is not a game point obtained in the game, it does not allow the user to participate the game. Here, the purchase condition includes a payment method with respect to the item to be purchased and a determination whether o not the item is paid.

The above programs are stored in a recording medium such as a hard disk, RAM, ROM, compact disc, DVD, CD-ROM, optical magnetic disc, floppy disk, digital tape, memory stick, etc and then read therefrom.

The terminal 16, the operator server 12 and the game server used in the present invention are implemented based on the IBM compatible personal computer and adapt the windows NT as an operating system. The peripherals (for example, mouse, speaker, monitor, etc.) used in the present invention are not shown in the drawings and are well known devices.

In addition, as a computer language, PHP4.0 and JavaScript are used inconsideration with the speed, security and expansion characteristic. Also, DBMS of the system according to the present invention adapts MySQL proved already on its stability.

In the present invention, various modifications may be possible by a person skilled in the art with respect to the principal guaranteeing game system on the internet and a recording medium. For example, the prices of the items may be set as 10,000won, 500,000won, 1,000,000won, 500,0000won, 10,000,000won, 50,000,000won and 100,000,000won according to the kinds and characteristic of the items.

In addition, the items described in the above include a bond, apartment, golf membership card, visible or non-visible items issued from a bank as well as all items (for example, computer, DVD player, walkman, cellular phone, agricultural and marine products, home appliances, clothes, fashion grocery, etc.) purchased or joint-purchased through the wire or wireless internet.

As a payment method for purchasing the items according to the present invention, a cash, credit card, property stored card, non-bankbook deposit method, cellular phone payment method, PDA, electronic money, etc. are used.

The system server may further include a separate financial server for exclusively performing an on-line remittance, credit card payment function, etc. which is not shown in the drawings explaining the embodiments. Here, the above financial server may be replaced with a server in a bank. For example, if the operator 12 cooperates with the server (not shown) of the bank, thereby automatically judging whether money is inputted thereto or remitted therefrom.

What we have been described in the above embodiments is that, in the system and method according to the present invention, the internet users purchase the items through a shopping mall connected with a game site managed by the same internet company as the shopping mall, receive a coupon to which the game point corresponding to the purchased items is allocated and play a game by connecting to the game site.

However, the system and method of the present invention may be further adapted to a coupon with a relatively lower price, which is issued from a shopping mall managed with an internet company different from that of a game site but they are previously cooperated each other, and which allows the purchaser to connect to the game site and to play a game of the game site. Namely, an internet company managing a game site and a shopping mall can cooperate with another internet company, so that, if a purchaser buys an item and a coupon corresponding to the item sold at another shopping mall managed by another internet company, he/she can connect to the game site and play a game provided from therefrom using the game point allocated in the coupon. Therefore, another internet company may obtain a profit by selling the items in the shopping mall operated by itself to the user, and the game site may obtain a profit which is produced as another internet company buys the discounted coupon with a game point smaller than the game point corresponding to the price of the item sold by the shopping mall operated by the game site.

In addition, even though the system above according to the present invention operates so that the items are purchased in the shopping mall through the wire internet by an internet user and the user can play the game in the game site, it may be easily modified to purchase the items in a wireless internet or wireless communication such as a PDA, and to play the game.

### INDUSTRIAL APPLICATABILITY OF THE INVENTION

In the principal guaranteeing game system on the internet and a recording medium according to the present invention, it is possible to purchase various items on the internet and receive a game point corresponding to the purchased amount. Even when the user loses all game point, it is possible to guarantee the items as much as the principals. Namely, even when the user freely plays the game and lose all game points, it is possible to guarantee the items by the principal because the purchased items were delivered to the purchaser by an delivery company irrespective of the game point.

In addition, it is possible to play various card games provided on the internet without any burden. In the case that a certain game point is obtained, since it is awarded by the amount corresponding to the game point, each member may have an additional profit. Namely, in the principal guaranteeing game system on the internet and a recording medium according to the present invention, it is possible to safely guarantee the principal of the items and have an additional economical profit based a result of the game.

1. A principal guaranteeing game system on an internet, comprising:
(1) servers (12 and 14) including:
(1-i) a means for transferring an item data including an item name, item price, and a period determined according to the item purchase principal to an internet (10);
(1-ii) a judging means for receiving a purchase data of the item from a member and judging whether a purchase condition is satisfied;
(1-iii) a giving means for outputting a delivery instruction of the item based on the purchase data and giving a game point corresponding to the item price to the member;
(1-iv) a game means for proceeding a game on the internet using the game point and for increasing or decreasing the game point according to a result of the game;
(1-v) a period expiration judging means for judging whether or not the period determined according the item purchase principal is expired;
(1-vi) a game point judging means for judging whether there is a game point obtained in the game with respect to a game point increased or decreased by the game means; and
(1-vii) a remitting means for remitting a property corresponding to the game point obtained in the game to an account of a corresponding member in the case that the period determined according to the item purchase principal is judged to be expired by the period expiration judging means, and the game point obtained in the game is judged to be remained by the game point judging means; and
(2) a terminal 16 including:
(2-i) a receiving means for receiving the item data through the internet 10;
(2-ii) a purchase data transferring means for receiving the purchase data and transferring to the server 12 and receiving the game point; and
(2-iii) a betting means for being cooperated with the game means and betting the game by increasing or decreasing the game point.

2. The system of claim 1, wherein said purchase condition further includes the kinds of a payment means and a determination whether the payment is paid.

3. The system of claim 2, wherein said payment means is a non-bankbook deposit, credit card, cash card, property stored card, cellular phone payment and PDA.

4. The system of claim 1, wherein said game means includes an electronic game such as a card game or slot machine, video game, and kino.

5. The system of either claim 1 or claim 4, wherein said purchase data is a bank name, account number, password, amount and purchaser's name data.

6. The system of either claim 1 or claim 4, wherein said game point is implemented based on the unit of money and is the same as the item price.

7. The system of either claim 1 or claim 4, wherein said money is an electronic money or cash.

8. The system of either claim 1 or claim 4, wherein said server is connected to a wired or wireless internet.

9. The system of either claim 1 or claim 4, wherein said item is visible or non-visible type.

10. The system of either claim 1 or claim 4, wherein said terminal includes a personal computer, PDA and a cellular phone.

11. The system of either claim 1 or claim 4, wherein said item is sold in a shopping mall managed by another internet company cooperated with the game site.

12. The system of claim 11, wherein said game point allocated to the item sold in the shopping mall managed by another internet company is relatively smaller than a game point allocated to the same item sold in a shopping mall managed by an internet company together with the game site.

13. A principal guaranteeing game method on the internet, comprising the steps of:
preparing step, including:
connecting through the internet; and
registering a member or logging in;
purchasing an item;
transferring an item data including a name of the purchased item, price of the purchased item, a period determined according to a purchase principal of the purchased item to a terminal (16) through the internet (10) and displaying the same on the terminal;
transferring a purchase data of the item inputted from the member computer (16) to the server (12) and judging whether the purchase date is satisfied with a purchase condition;
outputting an item delivery instruction based on the purchase data in the case that the purchase date is satisfied with the purchase condition, and giving a game point corresponding to the price of the item to the member;
betting the game using a game point and participating the game on the internet (10) and increasing or decreasing the game point based on a result of the game;
judging whether the period determined according to the purchase principal of the item data is expired;
judging whether there is a game point obtained in the game when the period determined according to the purchase principal of the item is expired;
providing property corresponding to the game point obtained in the game when the period determined according to the purchase principal of the item data is expired and there is a game point obtained in the game; and
preventing the user from participating the game when there is not a game point obtained in the game.

14. The method of claim 13, further comprising a step in which the user continuously participate the game when the period determined according to the purchase principal is not expired, and there is a game point obtained in the game.

15. The method of claim 13, wherein said purchase condition further comprises a determination whether the amount corresponding to the purchase item is paid.

16. The method of claim 13, wherein said providing property step includes an electronic money and cash.

17. The method of claim 13, further comprising a step for re-purchasing an item using a game point obtained in the game.

18. The method of claim 17, wherein said re-purchase item is implemented to allocate a game point corresponding to the price of the re-purchase item.

19. A recording medium capable of being executed in a computer, comprising:
a program code in which a user connected through a wired or wireless internet registers as a member or a previously registered member logs in;
a program code in which an item data including a name of a purchased item (S10), a price of the purchased item, and a period determined according to a purchase principal of the purchased item to a terminal (16) through the internet;
a program code in which the purchased data of the item inputted from the member computer (16) is transferred to the server (12) and the purchased data is judged to be satisfied with the purchase condition;
a program code in which a delivery instruction of the item is outputted based on the purchase data when the purchase condition is satisfied, and the game point corresponding to the price of the item is given to the member;
a program code in which the game is proceeded on the internet (10) based on the betted game point and the game point is increased or decreased based on a result of the game;
a program code in which it is judged whether the period determined according to the purchase principal of the item data is expired;
a program code in which it is judged whether there is a game point obtained in the game when the period determined according to the purchase principal of the item is expired;
a program code in which an instruction for outputting a property corresponding to the game point obtained in the game is outputted, in the case that the period determined according to the purchase principal of the item data is expired and there is a game point obtained in the game; and
a program code in which the user is prohibited to participate the game, if there is not a game point obtained in the game.

20. The recording medium of claim 19, wherein said computer further includes PDA, cellular phone, and mobile communication system.

21. The recording medium of claim 19, wherein said purchase condition is a determination whether a payment of the item is paid.

22. The recording medium of claim 19, wherein said purchased items are sold in a shopping mall operated by another internet company different from that of the game site.
